(19) United States
(12) Patent Application Publication
(10) Pub. No.: US 2025/0366407 A1
(43) Pub. Date: Dec. 4, 2025

(54) Intelligent, self watering, auto rotating Planter

(71) Applicant: Diante Brown, Haines City, FL (US)

(72) Inventor: Diante Brown, Haines City, FL (US)

(21) Appl. No.: 18/675,150

(22) Filed: May 28, 2024

(51) Int. Cl. A01G 9/02; A01G 9/26; B25J 11/00; G06N 20/00

(52) U.S. Cl. CPC A01G 9/02; A01G 9/26; B25J 11/00; G06N 20/00

(57) ABSTRACT

A robotic device and method for optimizing sunlight exposure for plants using machine learning and artificial intelligence are disclosed. The device comprises a rotatable platform supporting plants, light sensors, a power source, and a control system. The method involves collecting sunlight intensity data, analyzing it using a machine learning algorithm to determine an effective rotation pattern, and determining a rotation schedule using an artificial intelligence algorithm based on predicted sunlight patterns. The control system actuates the motorized base to rotate the platform according to the schedule, optimizing sunlight exposure for the plants. The device may include additional features such as a wireless communication module, watering system, and associated application. The invention leverages advanced technologies to provide a novel and efficient solution for promoting healthier plant growth and higher yields.

### BACKGROUND

The present invention relates to the field of plant cultivation and, more specifically, to a method and system for optimizing sunlight exposure for plants using a robotic device with light sensors, machine learning, and artificial intelligence.

Proper sunlight exposure is crucial for the healthy growth and development of plants. However, ensuring optimal sunlight exposure can be challenging, especially in areas with limited or inconsistent sunlight. Traditional methods of plant cultivation often rely on fixed positions or manual adjustments, which can be labor-intensive and inefficient.

Various technologies have been developed to address this issue. For example, solar tracking systems have been used to orient solar panels towards the sun for maximum energy capture. One such system is described in U.S. Pat. No. 9,182,153 B2, which discloses a ball bearing tracker assembly that enhances the output efficiency of solar panels by 20% to 40% compared to fixed solar panels. The assembly includes a novel, low-friction, swivel-positioning device that allows rotation on a ball joint, providing a full range of motion to ensure maximum sunlight capture.

In addition to solar tracking, automated irrigation systems have been developed to optimize water management in plant cultivation. U.S. Patent Application Publication No. 2016/0202679 A1 describes an automated irrigation control system that includes a crop sensor physically attached to a crop and a light-sensitive sensor configured to detect light intensity. The system determines an irrigation schedule based on the light intensity signal and generates an irrigation control signal to control the irrigation of the crop.

While these technologies have advanced the field of plant cultivation, there remains a need for a consumer scale efficient solution that integrates sunlight optimization, machine learning, and artificial intelligence specifically to enhance plant growth and health. The present invention addresses this need by providing a robotic device and method that automatically adjusts the orientation of plants based on real-time sunlight data, learned plant growth patterns, and predicted sunlight conditions.

### SUMMARY

The present invention addresses the aforementioned needs by providing a robotic device and method for optimizing sunlight exposure for plants using machine learning and artificial intelligence. The robotic device comprises a platform configured to support one or more plants, a motorized base enabling rotation of the platform, a plurality of light sensors disposed on the platform, a power source, and a control system with a processor and memory.

The method involves collecting sunlight intensity data from the light sensors, analyzing the data using a machine learning algorithm to determine an effective rotation pattern based on the plants' light absorption and growth patterns, and determining a rotation schedule using an artificial intelligence algorithm based on the effective rotation pattern and predicted sunlight patterns. The control system then actuates the motorized base to rotate the platform according to the determined schedule, thereby optimizing sunlight exposure for the plants.

The machine learning algorithm is trained on historical sunlight intensity and plant growth data, while the artificial intelligence algorithm may be a deep learning neural network that predicts future sunlight patterns based on historical weather data and current forecasts. The method further includes monitoring the plants' growth rate and health indicators and adjusting the rotation schedule accordingly.

The robotic device may also include additional features such as a wireless communication module for receiving user preferences and settings, a watering system for monitoring soil moisture levels and watering the plants as needed, and an associated mobile or web-based application to facilitate further user interaction with the robotic device.

By leveraging advanced technologies such as machine learning and artificial intelligence, the present invention provides a novel and efficient solution for optimizing sunlight exposure for plants, ultimately promoting healthier growth and higher yields.

Additional features and advantages of the invention will be set forth in the description which follows, and in part will be obvious from the description, or may be learned by the practice of the invention. These and other features of the present invention will become more fully apparent from the following description or may be learned by the practice of the invention as set forth hereinafter.

### BRIEF DESCRIPTION OF THE DRAWINGS

The various exemplary embodiments of the present invention. which will become more apparent as the description proceeds, are described in the following detailed description in conjunction with the accompanying drawings, in which:

FIG. 1 illustrates a system overview of the robotic device for optimizing sunlight exposure for one or more plants.

FIG. 2 depicts a block diagram of the control system of the robotic device.

FIG. 3 presents a flowchart illustrating and detailing the key steps of the sunlight optimization method performed by the robotic device.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein. each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might.” or “may.” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

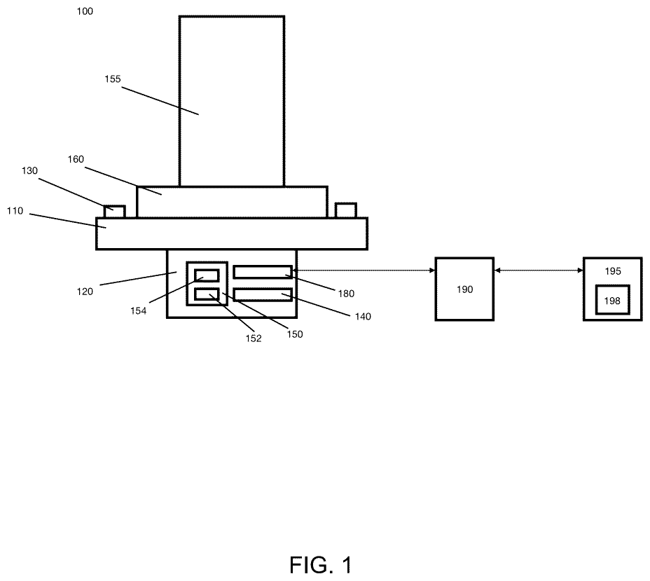

FIG. 1 illustrates a system overview of the robotic device 100 for optimizing sunlight exposure for one or more plants. The robotic device 100 comprises a platform 110 configured to support the one or more plants. The platform 110 is coupled to a motorized base 120 that enables rotation of the platform 110 in multiple directions, such as clockwise and counter clockwise rotation about a vertical axis. This rotation capability allows the robotic device 100 to adjust the orientation of the plants relative to the sun throughout the day. The motorized base 120 may utilize stepper motors, servo motors, or brushless DC motors controlled by motor drivers such as the L298N H-bridge motor driver to precisely rotate the platform 110.

A plurality of light sensors 130 are attached to the platform 110. The light sensors 130 comprise photoresistors such as the GL5516 LDR, photodiodes like the BPW34, photovoltaic cells such as the MP3-37, or any combination thereof. These sensors 130 are configured to collect data on sunlight intensity reaching different parts of the one or more plants supported by the platform 110. The collected sunlight intensity data is used by the robotic device 100 to optimize the plants' exposure to sunlight. The light sensors 130 are connected to analog input pins of a microcontroller, such as an Arduino Uno, for data acquisition and processing.

The robotic device 100 further comprises a power source 140, such as a rechargeable lithium-ion battery pack or a monocrystalline silicon solar panel, that supplies power to the various components of the device. A control system 150, including a processor 152 such as the Raspberry Pi microcontroller and a memory 154 like the AT24C256 EEPROM, is responsible for controlling the operation of the robotic device 100. The memory 154 stores instructions that, when executed by the processor 152, cause the control system 150 to analyze the collected sunlight intensity data using a machine learning algorithm such as a Support Vector Machine (SVM) implemented using the scikit-learn library in Python, determine an effective rotation pattern and schedule based on the analysis and predicted sunlight patterns using an artificial intelligence algorithm like a Long Short-Term Memory (LSTM) neural network implemented with the Keras library, and actuate the motorized base 120 to rotate the platform 110 according to the determined schedule.

The robotic device 100 also includes a watering system 160 integrated into the platform 110. The watering system 160 is configured to provide water to the plants 155 based on a watering schedule determined by the control system 150. The watering schedule may be determined based on an analysis of the collected sunlight intensity data and soil moisture sensor data, such as from the Gravity Analog Capacitive Soil Moisture Sensor, using the machine learning algorithm like a Random Forest classifier. The watering system 160 may comprise a submersible water pump, controlled by a relay module like the 1-Channel 5V Relay Module connected to a digital output pin of the microcontroller.

Finally, the robotic device 100 includes a communication module 180 that enables wireless communication with a remote server 190. The communication module 180 may be a Wi-Fi module like the ESP8266 or a Bluetooth module such as the HC-05. The communication module 180 may be used to transmit collected data to the server for further analysis using protocols like HTTPS, receive updates to the machine learning and artificial intelligence algorithms, and enable remote monitoring and control of the robotic device 100 through a web-based or a mobile application 195 hosted on a client device 198 wherein a client device 195 could be a mobile phone, laptop or any personal computing device.

The application 195 in this embodiment is a mobile application developed in Swift and/or Java development languages making it IOS and Android compatible, may display information comprising the collected sunlight intensity data, the determined effective rotation pattern, and the rotation schedule. The mobile application may also allow a user to manually override the determined rotation schedule if desired.

In a preferred embodiment the plurality of light sensors 130, are disposed at various locations on the platform 110. This arrangement allows the sensors 130 to collect sunlight intensity data from different parts of the plants, providing a comprehensive understanding of the plants' light exposure.

Additionally, the control system 150 is electrically connected to the light sensors 130 and the motorized base 120. The processor 152 of the control system 150 receives the sunlight intensity data from the light sensors 130 and uses this data to determine the optimal rotation pattern and schedule for the platform 110. Based on this determination, the processor 152 sends control signals to the motorized base 120 to actuate the rotation of the platform 110, thereby optimizing the sunlight exposure for the plants.

The memory 154 of the control system 150 stores the machine learning and artificial intelligence algorithms used to analyze the sensor data and determine the optimal rotation pattern and schedule.

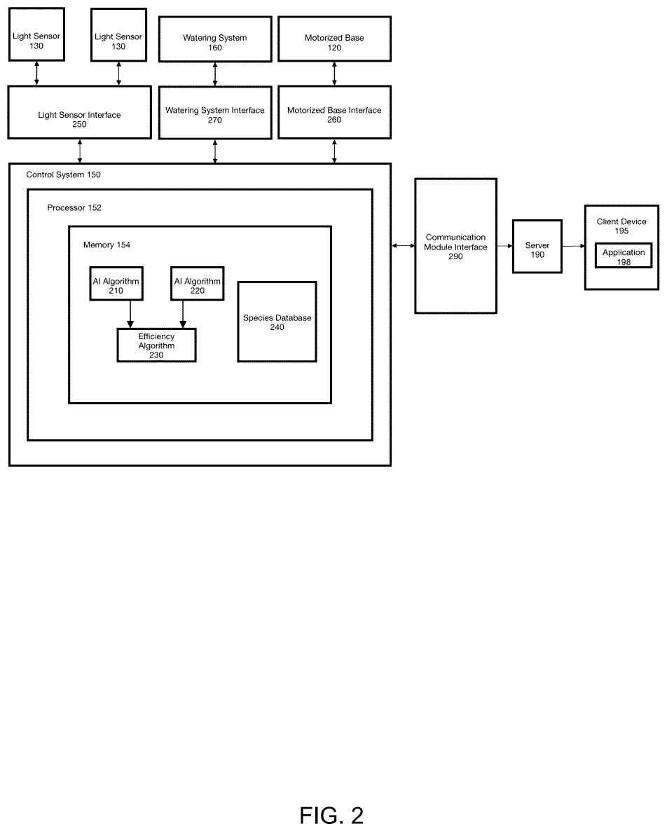

FIG. 2 depicts a block diagram of the control system 150 of the robotic device 100. The control system 150 includes a processor 152, that executes instructions stored in the memory 154 to control the various functions of the robotic device 100.

The memory 154 stores a variety of machine learning algorithms, comprising decision trees, random forests, support vector machines (SVMs), and artificial neural networks (ANNs). These supervised learning algorithms are trained on historical sunlight intensity data and corresponding plant growth data to determine effective rotation patterns.

The memory 154 also stores artificial intelligence algorithms, such as deep learning neural networks and reinforcement learning algorithms. The deep learning neural networks predict future sunlight patterns based on historical weather data and current weather forecasts, while the reinforcement learning algorithms optimize the rotation schedule based on a reward function that maximizes plant growth and health.

An efficiency sharing algorithm 230 is also stored in the memory 154. This algorithm utilizes the predictions from the artificial intelligence algorithms 220 and the machine learning algorithms 210 to optimize the distribution of the daily predicted sunlight to the one or more plants for optimal plant growth.

The efficiency sharing algorithm 230 algorithm takes into account factors such as the individual plant's light requirements, growth stage, and the predicted sunlight intensity at different times of the day. By analyzing these factors, the efficiency sharing algorithm 230 generates a dynamic rotation schedule that ensures each plant receives the optimal amount of sunlight exposure based on its specific needs. This optimized sunlight distribution promotes healthy plant growth and maximizes the overall efficiency of the robotic device 100. The efficiency sharing algorithm is implemented using Python programming language and utilizes libraries such as NumPy for numerical computations and Pandas for data manipulation. The algorithm continuously adapts the rotation schedule based on real-time data from the light sensors 130 and the updated predictions from the AI and machine learning models, ensuring that the plants always receive the most beneficial sunlight exposure possible.

The memory 154 further includes a plant species sunlight database 240, which stores optimal sunlight exposure patterns for different plant species. This database 240 is used by the processor 152 to select an initial rotation schedule based on the species of the plants being supported by the platform 110.

The control system 150 interfaces with various components of the robotic device 100 through a series of interfaces. A light sensor interface 250 connects the processor 152 to the light sensors 130, enabling the processor to receive sunlight intensity data collected by the sensors. A motorized base interface 260 allows the processor 152 to send control signals to the motorized base 120 to actuate rotation of the platform 110 according to the determined rotation schedule.

A watering system interface 270 enables the control system 150 to monitor soil moisture levels using soil moisture sensors and to activate the watering system 160 when necessary to maintain optimal soil moisture for the plants.

A communication module interface 290 connects the processor 152 to a wireless communication module, such as a Wi-Fi or cellular module, enabling the robotic device 100 to transmit collected data and receive updates to the machine learning and artificial intelligence algorithms from a remote server 190 and communicate with the web-based or mobile application 195 hosted on a user device 198.

The arrows in the block diagram represent the flow of data and control signals between the various components. Sensor data flows from the light sensors 130 and soil moisture sensors through the respective interfaces to the processor 152. The processor analyzes this data using the machine learning algorithms 210 and artificial intelligence algorithms 220, and sends control signals to the motorized base 120 and watering system 160 through their respective interfaces. User input and external communications flow through the user interface 280 and communication module interface 290, respectively, to the processor 152, which adjusts the rotation and watering schedules accordingly.

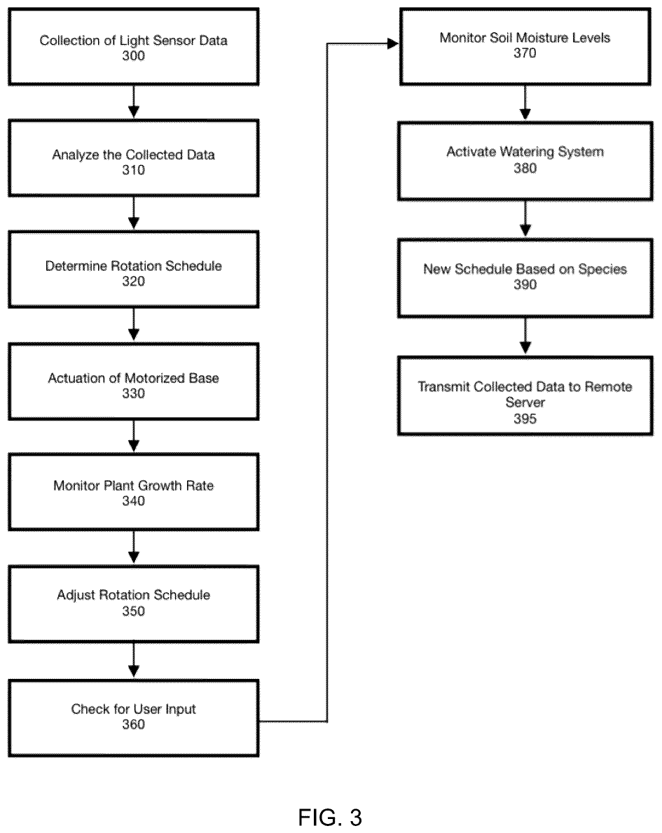

FIG. 3 presents a flowchart illustrating and detailing the key steps of the sunlight optimization method performed by the robotic device 100. The method begins at step 300 with the collection of light sensor data by the light sensors 130 disposed on the platform 110. The processor 152 receives this data via the light sensor interface 250.

At step 310, the processor 152 analyzes the collected sunlight intensity data using the machine learning algorithms 210 stored in the memory 154. Specifically, a supervised learning algorithm trained on historical sunlight intensity data and corresponding plant growth data, is used to determine an effective rotation pattern based on the plants' light absorption and growth patterns.

Next, at step 320, the processor 152 determines a rotation schedule for the platform 110 using the artificial intelligence algorithms 220, such as deep learning neural networks and reinforcement learning algorithms. The deep learning neural networks predict future sunlight patterns based on historical weather data and current weather forecasts, while the reinforcement learning algorithms optimize the rotation schedule based on a reward function that maximizes plant growth and health.

At step 330, the control system 150 actuates the motorized base 120 via the motorized base interface 260 to rotate the platform 110 according to the determined rotation schedule, thereby optimizing sunlight exposure for the plants.

The method then enters a monitoring and adjustment loop. At step 340, the control system 150 monitors the plants' growth rate and health indicators. If the growth rate or health indicators fall below optimal levels, the processor 152 adjusts the rotation schedule at step 350 based on the monitored data.

At step 360, the control system 150 checks for user input received via the mobile or web application 280. If user preferences or settings are received, the processor 152 adjusts the rotation schedule at step 350 based on the user input.

The control system 150 also monitors soil moisture levels using soil moisture sensors at step 370. If the soil moisture levels fall below a predetermined threshold, the control system 150 activates the watering system 160 via the watering system interface 270 at step 380 to water the plants.

If the robotic device 100 is supporting a new species of plant, the processor 152 selects an initial rotation schedule at step 390 based on the plant species database 240 stored in the memory 154. This database contains optimal sunlight exposure patterns for different plant species.

Throughout the process, the robotic device 100 may transmit collected data and determined schedules to a remote server 190 via the communication module interface 290 at step 395. The remote server may perform further analysis and storage of the data, and transmit updates to the machine learning algorithms 210 and artificial intelligence algorithms 220, which are received by the robotic device 100 via the communication module interface 290.

The method continues to loop through steps 340-395, continuously monitoring and adjusting the rotation schedule, watering the plants as needed, and communicating with the remote server, until the plants reach maturity or the user ends the process.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A method for optimizing sunlight exposure for a plant, the method comprising:
providing a robotic device comprising a platform configured to support the one or more plants, the platform coupled to a motorized base enabling rotation of the platform in multiple directions, a plurality of light sensors disposed on the platform, a power source, and a control system comprising a processor and a memory;
collecting, by the plurality of light sensors, data on sunlight intensity reaching different parts of the one or more plants;
analyzing, by the processor executing a machine learning algorithm stored in the memory, the collected sunlight intensity data to determine an effective rotation pattern based on the one or more plants' light absorption and growth patterns;
determining, by the processor executing an artificial intelligence algorithm stored in the memory, a rotation schedule for the platform based on the effective rotation pattern and predicted sunlight patterns; and
actuating, by the control system, the motorized base to rotate the platform according to the determined rotation schedule, thereby optimizing sunlight exposure for the one or more plants.

2. The method of claim 1, wherein the machine learning algorithm is a supervised learning algorithm trained on historical sunlight intensity data and corresponding plant growth data.

3. The method of claim 1, wherein the artificial intelligence algorithm is a deep learning neural network that predicts future sunlight patterns based on historical weather data and current weather forecasts.

4. The method of claim 1, wherein the method further comprises an efficiency sharing algorithm which utilizes the predictions from the artificial intelligence algorithm and the machine learning algorithm to optimize the distribution of the daily predicted sunlight to the one or more plants for optimal plant growth.

5. The method of claim 1, further comprising:
monitoring, by the control system, the one or more plants' growth rate and health indicators; and
adjusting, by the processor, the rotation schedule based on the monitored growth rate and health indicators.

6. The method of claim 1, wherein the robotic device further comprises a wireless communication module, the method further comprising:
receiving, by the wireless communication module, user preferences and settings from a remote user device; and
adjusting, by the control system, the rotation schedule based on the received user preferences and settings.

7. The method of claim 1, wherein the robotic device further comprises a watering system, the method further comprising:
monitoring, by the control system, soil moisture levels of the one or more plants; and
activating, by the control system, the watering system to water the one or more plants when the soil moisture levels fall below a predetermined threshold.

8. The method of claim 1, wherein the plurality of light sensors comprise photoresistors, photodiodes, or photovoltaic cells.

9. The method of claim 1, further comprising:
storing, in the memory, a database of optimal sunlight exposure patterns for different plant species; and
selecting, by the processor, an initial rotation schedule based on a species of the one or more plants and the corresponding optimal sunlight exposure pattern from the database.

10. The method of claim 2, wherein the supervised learning algorithm is selected from the group consisting of decision trees, random forests, support vector machines, and artificial neural networks.

11. The method of claim 3, wherein the artificial intelligence algorithm used to determine the rotation schedule is a reinforcement learning algorithm that optimizes the rotation schedule based on a reward function that maximizes plant growth and health.

12. The method of claim 1, further comprising:
transmitting, by a communication module of the robotic device, the collected sunlight intensity data and the determined rotation schedule to a remote server for further analysis and storage; and
receiving, by the communication module, updates to the machine learning algorithm and the artificial intelligence algorithm from the remote server.

13. The method of claim 1, further comprising:
providing a mobile application configured to communicate with the robotic device via the wireless communication module, the mobile application comprising:
a user interface for displaying the collected sunlight intensity data, the determined effective rotation pattern, and the rotation schedule;
an input interface for receiving user preferences, settings, and manual overrides of the rotation schedule; and
wherein the processor is further configured to:
adjust the rotation schedule based on the user preferences, settings, and manual overrides received from the mobile application; and
transmit updates on the status and performance of the robotic device, including the collected sunlight intensity data, the determined effective rotation pattern, and the adjusted rotation schedule, to the mobile application for display on the user interface.

14. The method of claim 1, wherein the robotic device further comprises a watering system integrated into the platform, the method further comprising:
determining, by the control system, a watering schedule based on an analysis of the collected sunlight intensity data and soil moisture sensor data using the machine learning algorithm; and
activating, by the control system, the watering system to provide water to the one or more plants based on the determined watering schedule.

15. A system for optimizing sunlight exposure for one or more plants, the system comprising:
a robotic device comprising:
a platform configured to support the one or more plants;
a motorized base coupled to the platform, the motorized base enabling rotation of the platform in multiple directions;
a plurality of light sensors disposed on the platform, the plurality of light sensors configured to collect data on sunlight intensity reaching different parts of the one or more plants;
a power source configured to supply power to the robotic device; and
a control system comprising a processor and a memory, the memory storing instructions that, when executed by the processor, cause the control system to:
analyze, using a machine learning algorithm, the collected sunlight intensity data to determine an effective rotation pattern based on the one or more plants' light absorption and growth patterns;
determine, using an artificial intelligence algorithm, a rotation schedule for the platform based on the effective rotation pattern and predicted sunlight patterns; and
actuate the motorized base to rotate the platform according to the determined rotation schedule, thereby optimizing sunlight exposure for the one or more plants.

16. The system of claim 15, wherein the plurality of light sensors comprise photoresistors, photodiodes, or photovoltaic cells.

17. The system of claim 15, wherein the machine learning algorithm is a supervised learning algorithm trained on historical sunlight intensity data and corresponding plant growth data.

18. The system of claim 17, wherein the supervised learning algorithm is selected from the group consisting of decision trees, random forests, support vector machines, and artificial neural networks.

19. The system of claim 15, wherein the artificial intelligence algorithm used to determine the rotation schedule is a reinforcement learning algorithm that optimizes the rotation schedule based on a reward function that maximizes plant growth and health.

20. The system of claim 15, further comprising a communication module configured to transmit the collected sunlight intensity data and the determined rotation schedule to a remote server for further analysis and storage.

21-27. (canceled)
